(19) United States
(12) Patent Application Publication
(10) Pub. No.: US 2013/0329751 A1
(43) Pub. Date: Dec. 12, 2013

(54) REAL-TIME COMMUNICATION

(71) Applicant: MICROSOFT CORPORATION, Redmond, WA (US)

(72) Inventors: David Zhao, Solna (SE); Christoffer Asgaard Rodbro, Stockholm (SE)

(73) Assignee: MICROSOFT CORPORATION, Redmond, WA (US)

(21) Appl. No.: 13/678,508

(22) Filed: Nov. 15, 2012

(30) Foreign Application Priority Data
Jun. 8, 2012 (GB) 1210090.5

(51) Int. Cl. H04L 29/06

(52) U.S. Cl. CPC H04L 65/1066
USPC 370/468

(57) ABSTRACT

Receiver, computer program product and method for processing data of a real-time communication event. A processing module of the receiver implements a real-time communication application to receive a data stream of the real-time communication event. Data of the received data stream is output to a user in the real-time communication event. Interaction of the user with the real-time communication application during the real-time communication event is determined, and the data rate of the received data stream in the real-time communication event is controlled based on the determined interaction.

### RELATED APPLICATION

This application claims priority under 35 USC 119 or 365 to Great Britain Application No. 1210090.5 filed 8 Jun. 2012, the disclosure of which is incorporated in its entirety.

### BACKGROUND

Real-time communication systems allow real-time communication events to proceed between end points in the real-time communication system. For example, where the end points of a real-time communication event are user terminals, each associated with respective users, a real-time communication event (e.g. an audio or video call) allows real-time communication to occur between the users. Each end point of the real-time communication event implements a real-time communication application in order to handle real-time communication events. Data streams are transmitted between the end points of a real-time communication event over a network. For example, the network may be a packet based network such as the Internet and the data streams may comprise sequences of data packets, e.g. packetized and processed according to Internet Protocol (IP). Alternatively, or additionally, the network may comprise other types of networks such as a mobile telephony network or the public switched telephone network (PSTN).

Increasing a data rate of a data stream transmitted in a real-time communication event may lead to a higher quality in the data received at the receiver of the real-time communication event. For example, if the real-time communication event is a video conferencing event, then a higher data rate (i.e. a higher bandwidth) used for the video data allows a higher quality video signal to be received and output at the receiver. A higher quality video signal may for example have a higher frame rate, resolution or size, thereby requiring more data to be transmitted. It can be beneficial, in some situations, to increase the data rate (i.e. bandwidth) of a data stream in a real-time communication event. However, a real-time communication system has finite resources for communication between end points. Therefore, increasing the data rate (i.e. bandwidth) of a data stream in a real-time communication event may cause a delay in the receipt of data of a data stream at the receiver of the real-time communication event, which can be detrimental in some situations. A delay can be particularly detrimental for a communication event which is a real-time communication event because the delay may affect the ability of the communication event to function satisfactorily in real-time. The presence of a delay in the transmission path may be referred to herein as latency. For example, if the real-time communication event is a call in which two users are having a conversation, a delay of more than a few hundred milliseconds in the transmission of the data streams between the two end points of the call can severely affect the flow of the conversation and can result in more frequent instances of doubletalk where both users speak simultaneously and interrupt each other unintentionally. Therefore, in a real-time communication system a real-time communication application makes a trade-off between bandwidth and latency of the transmission of the data streams. For example in video conferencing, the higher the bandwidth consumed the higher the quality of the decoded video data, but this comes at the cost of increased latency.

Some bandwidth control methods are “delay adaptive” and can define a target roundtrip or end-2-end delay in a real-time communication event and can regulate the transmission rate to meet that target delay. The target delay is predetermined, or adapted according to the network conditions.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The inventors have realised that the data rate (i.e. bandwidth) of a data stream in a real-time communication event may be controlled based on a user's interaction in the real-time communication event. In particular, an optimal trade-off between bandwidth and latency may depend on how the user is using the real-time communication application. Therefore the optimal trade-off between bandwidth and latency may be determined based on how the user is using the real-time communication application. For example, when the user is not actively interacting, latency may be of lower concern, and therefore the real-time communication application may increase its bandwidth usage. The user's interaction with the real-time communication application may be monitored and used to better control the trade-off between latency and bandwidth of the data streams in a real-time communication event.

A real-time communication application may be implemented at a receiver of a real-time communication event. The real-time communication application may process data of the real-time communication event. In particular, the real-time communication application may receive a data stream of the real-time communication event and output data of the received data stream to a user. The user's interaction with the real-time communication application during the real-time communication event may be determined and the data rate of the received data stream may be controlled based on the determined interaction.

By controlling the data rate of the received data stream based on the user's interaction with the real-time communication application, the trade-off between bandwidth and latency may be adapted to suit the way in which the user is currently interacting with the real-time communication event. Therefore, if the user is interacting in a way in which he is particularly sensitive to increased latency (e.g. if the user is speaking in a call) then the data rate may be set relatively low to thereby allow the latency to be set relatively low compared to when the user is not so sensitive to increased latency (e.g. when the user is not speaking in the call). Similarly, if the user is interacting in a way in which he is particularly sensitive to increased quality of the received data (e.g. if the user is actively watching video data received in a video call) then the data rate may be set relatively high to thereby increase the quality of the received data compared to when the user is not so sensitive to increased quality of the received data (e.g. when the user's attention is not on the video data received in the video call).

### BRIEF DESCRIPTION OF THE DRAWINGS

For a better understanding of the various embodiments and to show how the same may be put into effect, reference will now be made, by way of example, to the following drawings in which:

FIG. 1 shows a communication system including two user terminals;

FIG. 2 shows a schematic view of a user terminal;

FIG. 3a is a flow chart for a process of receiving data in a real-time communication event;

FIG. 3b is a flow chart for a process of transmitting data in a real-time communication event; and

FIG. 3c is a flow chart for a process of controlling a real-time communication event.

### DETAILED DESCRIPTION

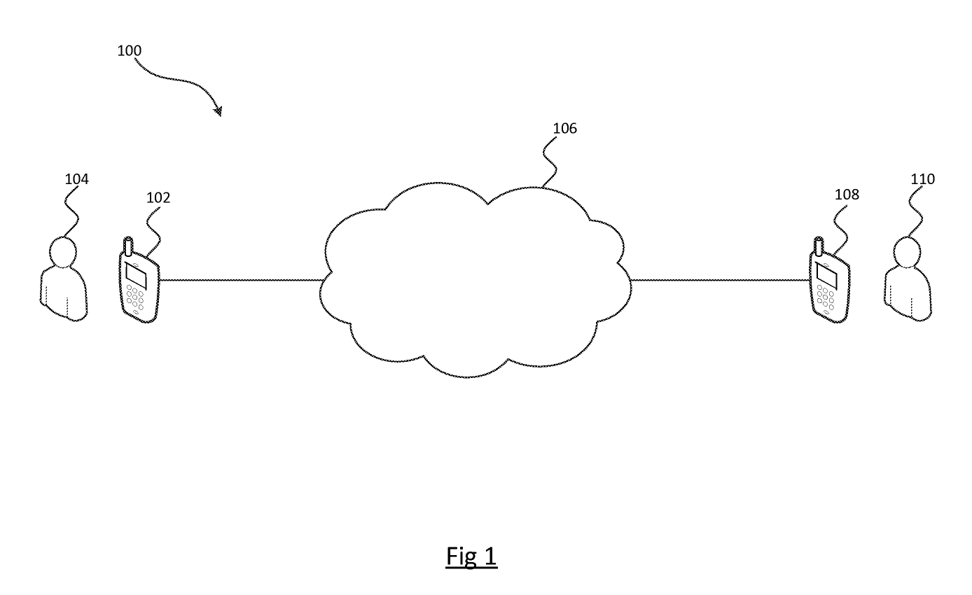

FIG. 1 shows a real-time communication system 100 comprising a first user 104 who is associated with a first user terminal 102 and a second user 110 who is associated with a second user terminal 108. In other embodiments the communication system 100 may comprise any number of users and associated user terminals. The user terminals 102 and 108 can communicate over the network 106 in the communication system 100, thereby allowing the users 104 and 110 to communicate with each other over the network 106. In the various embodiments the communication system 100 is a packet-based, P2P communication system, but other types of communication system could also be used, such as non-P2P, VoIP or IM systems. The network 106 may, for example, be the Internet or another type of network such as a telephone network (such as the PSTN or a mobile telephone network). Each of the user terminals 102 and 108 may be, for example, a mobile phone, a tablet, a laptop, a personal computer (“PC”) (including, for example, Windows™, Mac OS™ and Linux™ PCs), a gaming device, a television, a personal digital assistant (“PDA”) or other embedded device able to connect to the network 106. The user terminal 102 is arranged to receive information from and output information to the user 104 of the user terminal 102. The user terminal 102 comprises output devices such as a display and speakers. The user terminal 102 also comprises input devices such as a keypad, a touch-screen, a microphone for receiving audio signals and/or a camera for capturing images of a video signal. The user terminal 102 is connected to the network 106.

The user terminal 102 executes a communication client, provided by a software provider associated with the communication system 100. The communication client is a software program executed on a local processor in the user terminal 102. The client performs the processing required at the user terminal 102 in order for the user terminal 102 to transmit and receive data over the communication system 100. The client executed at the user terminal 102 may be authenticated to communicate over the communication system through the presentation of digital certificates (e.g. to prove that user 104 is a genuine subscriber of the communication system).

The user terminal 108 may correspond to the user terminal 102. The user terminal 108 executes, on a local processor, a communication client which corresponds to the communication client executed at the user terminal 102. The client at the user terminal 108 performs the processing required to allow the user 110 to communicate over the network 106 in the same way that the client at the user terminal 102 performs the processing required to allow the user 104 to communicate over the network 106. The user terminals 102 and 108 are end points in the real-time communication system 100. FIG. 1 shows only two users (104 and 110) and two user terminals (102 and 108) for clarity, but many more users and user terminals may be included in the communication system 100, and may communicate over the communication system 100 using respective communication clients executed on the respective user terminals.

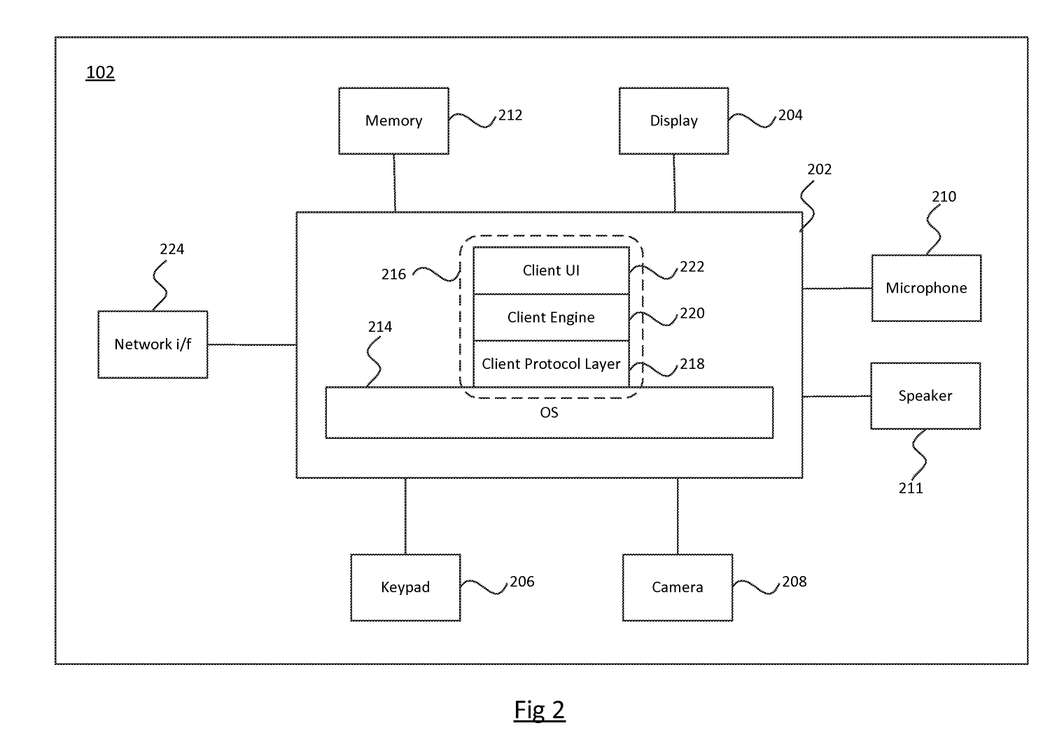

FIG. 2 illustrates a detailed view of the user terminal 102 on which is executed a communication client for communicating over the communication system 100. The user terminal 102 comprises a central processing unit (“CPU”) or “processing module” 202, to which is connected a display 204 such as a screen, a speaker 211, a memory 212 for storing data and input devices such as a keypad 206 and a camera 208 and a microphone 210. The display 204, keypad 206, camera 208, microphone 210, speaker 211 and memory 212 may be integrated into the user terminal 102 as shown in FIG. 2. In alternative user terminals one or more of the display 204, the keypad 206, the camera 208, the microphone 210, the speaker 211 and the memory 212 may not be integrated into the user terminal 102 and may be connected to the CPU 202 via respective interfaces. One example of such an interface is a USB interface. The CPU 202 is connected to a network interface 224 such as a modem for communication with the network 106. If the connection of the user terminal 102 to the network 106 is a wireless connection the network interface 224 may include an antenna for wirelessly transmitting signals to the network 106 and wirelessly receiving signals from the network 106. The network interface 224 may be integrated into the user terminal 102 as shown in FIG. 2. In alternative user terminals the network interface 224 is not integrated into the user terminal 102.

FIG. 2 also illustrates an operating system (“OS”) 214 executed on the CPU 202. Running on top of the OS 214 is a software stack 216 for the client software of the communication system 100. When executed on the CPU 202, the client software implements a real-time communication application, as described in more detail below. The software stack shows a client protocol layer 218, a client engine layer 220 and a client user interface layer (“UI”) 222. Each layer is responsible for specific functions. Because each layer usually communicates with two other layers, they are regarded as being arranged in a stack as shown in FIG. 2. The operating system 214 manages the hardware resources of the computer and handles data being transmitted to and from the network 106 via the network interface 224. The client protocol layer 218 of the client software communicates with the operating system 214 and manages the connections over the communication system. Processes requiring higher level processing are passed to the client engine layer 220. The client engine 220 also communicates with the client user interface layer 222. The client engine 220 may be arranged to control the client user interface layer 222 to present information to the user 104 via the user interface of the client and to receive information from the user 104 via the user interface.

The user terminal 108 is implemented in the same way as user terminal 102 as described above, wherein the user terminal 108 may have corresponding elements to those described herein in relation to user terminal 102.

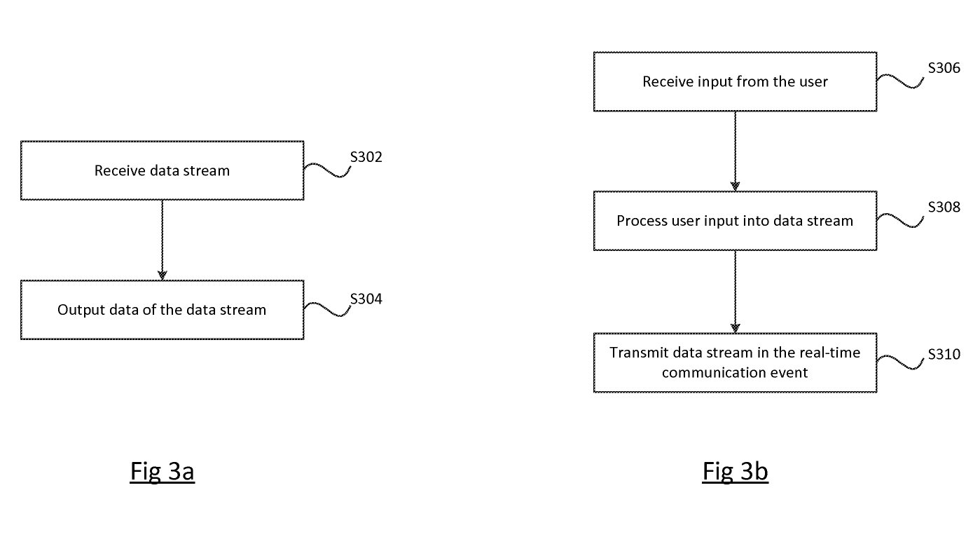

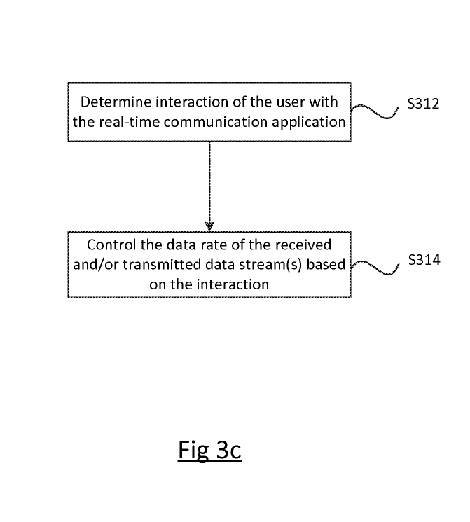

With reference to the flow charts shown in FIGS. 3a to 3c there follows a description of how the user terminal 102 processes data in a real-time communication event over the real-time communication system 100. In the examples described below the user 104 uses the user terminal 102 to engage in a real-time communication event, such as an audio or video call, with the user 110 who uses the user terminal 108. In the real-time communication event data streams may be sent in either or both directions between the user terminals 102 and 108 over the network 106. The user terminal 102 acts as a receiver in the real-time communication event when it receives a data stream from the user terminal 108. The user terminal 102 acts as a transmitter in the real-time communication event when it transmits a data stream to the user terminal 108.

FIG. 3a briefly illustrates the steps taken by the user terminal 102 when it acts as a receiver in the real-time communication event. In step S302 a data stream is received at the user terminal 102 from the user terminal 108 over the network 106 using the network interface 224. The data stream may comprise audio and/or video data, and/or other suitable data for use in the real-time communication event. The data in the data stream is transmitted over the network 106 according to a suitable protocol for transmission over the network. For example, if the network 106 is the Internet then the data in the data stream may be received according to Internet Protocol. The data in the received data stream may be processed (e.g. encoded and packetized) into data packets for transmission over the network 106. Methods for processing data for transmission over the network 106 are known in the art and are not described in detail herein.

In step S304 data of the received data stream is output from the user terminal 102 to the user 104. For example, video data (and/or other visual data such as text data) from the received data stream may be output from the display 204 of the user terminal 102. Audio data from the received data stream may be output from the speaker 211 of the user terminal 102. Step S304 of outputting the data may include processing the received data (e.g. to depacketize and decode the data) before outputting the data. The processing that occurs on the received data prior to outputting the data is complementary to the processing that is performed on the data prior to transmission of the data over the network 106. Methods for processing the data of the received data stream before outputting the data are known in the art and are not described in detail herein.

FIG. 3b briefly illustrates the steps taken by the user terminal 102 when it acts as a transmitter in the real-time communication event. In step S306 the user terminal 102 receives an input from the user 104 for transmission to the user terminal 108 in the real-time communication event. For example, the user input may be an audio signal received at the microphone 210. The user input may be an image or a video signal captured by the camera 208. An image captured by the camera 208 may or may not include an image of the user 104. For example, if the camera 208 captures frames of a video signal which include images of the user 104 then the video signal can be transmitted to the user terminal 108 in a video call thereby allowing the user 110 to view images of the user 102 in the video call. The user input received in step S306 may also comprise other types of input such as data (e.g. text data) inputted via the keypad 206 or via a touch-screen on the display 204.

In step S308 the user input is processed at the user terminal 102 into a format which is suitable for transmission over the network 106 to the user terminal 108 in the real-time communication event. For example, where the network 106 is the Internet, the user input may be processed into data packets according to the Internet Protocol as described above. For example, if the user input is an audio signal comprising speech of the user 104 then step S308 may involve encoding the audio input using a speech codec and according to a speech coding scheme. Similarly, if the user input is a video signal then step S308 may involve encoding the video input using a video codec and according to a video coding scheme. As described above, methods for processing the user input for transmission over the network 106 are known in the art and are not described in more detail herein.

In step S310 the data which has been processed in step S308 is transmitted over the network 106 from the user terminal 102 to the user terminal 108 in the real-time communication event. This involves sending the data using the network interface 224 onto the network 106.

The data is processed and transmitted according to a data rate for the data stream. As described above there is a trade-off between the data rate and the latency of the data stream.

While the real-time communication event proceeds, the method steps shown in FIG. 3c are implemented in order to control the data rate of the data streams transmitted in the real-time communication event based on the interaction of the user 104 with the real-time communication event, and in particular based on the interaction of the user 104 with the real-time communication application implemented by the client software executed at the user terminal 102.

In step S312 interaction of the user 102 with the real-time communication application is determined. Different aspects of the user's interaction may be determined in step S312 as described in more detail below.

In step S314 the data rate of the received data stream in the real-time communication event is controlled based on the user's interaction as determined in step S312. In some embodiments, in step S314, the data rate of the transmitted data stream in the real-time communication event may be controlled based on the user's interaction as determined in step S312.

This allows the optimal trade-off between bandwidth and latency to be controlled based on how the user is actually interacting with the communication event. For example, if the attention of the user 104 is on video data transmitted from the user terminal 108 in a video call then the quality of the received video data is more important than if the attention of the user 104 is not on the video data. Therefore the data rate of video data received at the user terminal 102 in a video call is controlled to be higher when the attention of the user 104 is on the video data than when the attention of the user 104 is not on the video data. As another example, if the user 104 is not communicating to the user 110 in a call (e.g. the user 104 has muted the microphone 210 or has initiated a “listening mode” in which the user 104 does not intend to send audio data to the far side of the call, or if the user 104 is not talking in an audio call) then maintaining a small latency for the data signal received at the user terminal 102 is not as important as when the user 104 is actively interacting in the call to send audio data to the far side of the call. Therefore, the data rate of the data signal received at the user terminal 102 in a call may be controlled to be higher when the user 104 is not communicating to the user 110 in a call than when the user 104 is communicating to the user 110 in the call.

In order to control the data rate of the received data stream and/or the transmitted data stream the real-time communication application at the user terminal 102 implements a data rate control method in order to determine a target value for the data rate. The target value may be the target data rate itself, or the target value may be another value from which the target data rate can be determined in step S308. For example, the target value may be a target queue size N_{Q} which the data stream should not exceed. In order to control the data rate of the received data stream a control signal may be sent from the user terminal 102 to a node in the network 106 which processes the data of the data stream before the data of the data stream is received at the user terminal 102 in the real-time communication event. The control signal may comprise an indication of a target data rate (e.g. the indication may be the target data rate itself or a target queue size N_{Q} as described above from which the node can determine the target data rate) thereby enabling the node to transmit the data stream at the target data rate in the real-time communication event. For example, the node may be the transmitter of the real-time communication event, i.e. the user terminal 108 in the examples described herein. Alternatively, the node may be an intermediate node in the network 106 via which the data stream is transmitted from the user terminal 108 to the user terminal 102.

In order to control the data rate of the transmitted data stream an indication of a target value for the data rate may be received from the user terminal 108. The target value is provided to an algorithm used in step S308 for processing the user input into a data stream. The target value is used in step S308 such that the data stream has the target data rate.

A data rate control method implemented by the real-time communication application implemented by the client software at the user terminal 102 may use a target queue size N_{Q}. A bandwidth estimation method may be used to estimate the bandwidth available to a real-time communication event through the network 106 using a packet delay noise term e_{d}, wherein the data rate can be controlled based on the estimated bandwidth. In these methods, the higher the N_{Q} or the e_{d}, the higher the transmission rate which is considered to be the optimum data rate in the trade-off between data rate and delay (or in other words, the trade-off between bandwidth and latency) for use on the channel.

Identified below are user behaviour patterns that may influence the trade-off between data rate and delay. There are described below examples, relating to the interaction of the user 104 with the real-time communication application implemented by the client software at the user terminal 102, that should lead to a higher optimum data rate at the cost of a higher delay in the trade-off between data rate and delay.

In order to determine interaction of the user with the real-time communication application the user terminal 102 (in particular the real-time communication application implemented by the client software at the user terminal 102) may determine whether the user 104 is inputting data to the real-time communication application for transmission in the real-time communication event. For example, the data rate of the received data stream in the real-time communication event may be controlled such that it is increased if the user is not inputting data to the real-time communication application for transmission in the real-time communication event.

In order to determine whether the user is inputting data to the real-time communication application for transmission in the real-time communication event the real-time communication application at the user terminal 102 may for example: (i) determine whether the user 104 has muted the microphone 210, (ii) determine whether the user 104 has activated a listening mode to be implemented by the real-time communication application at the user terminal 102, and/or (iii) detect at least one of audio or video input from the user 104.

The determination as to whether the user 104 has muted the microphone 210 may be performed in a number of different ways. For example, the user 104 may mute the microphone 210, using an interface in the real-time communication application, an interface in the operating system 214, or a control, such as a button, on an audio device comprising the microphone 210 (e.g. on a headset connected to the user terminal 102). If the user mutes the microphone 210 during the real-time communication event, this is a sign that the user 104 does not intend to interact with the far side in the real-time communication event.

In order to determine whether the user 104 has activated a listening mode at the user terminal 102, the real-time communication application may implement a “listening mode” interface via which the user 104 can actively tell the real-time communication application that he or she does not intend to interact with the far side.

In order to detect at least one of audio or video input from the user 104, the real-time communication application may determine whether the user 104 is talking (i.e. inputting audio data for transmission in the real-time communication event) or moving (i.e. inputting video data for transmission in the real-time communication event). In order to achieve this, the real-time communication application may monitor voice activity in an audio signal received with the microphone 210 and/or may monitor video activity in a video signal received with the camera 208. Methods for detecting user input in the audio signal received with the microphone 210 and in the video signal received with the camera 208 are known to a person skilled in the art and are not described in detail herein. If user input is not detected in the audio signal received with the microphone 210 or in the video signal received with the camera 208 then the real-time communication application may determine that the user 104 is not interacting with the far-side in the real-time communication event.

When the user 104 is not interacting with the far-side (e.g. when the user 104 is not sending data to the far side) in the real-time communication event, the user 104 is less sensitive to latency on the received data stream compared to when the user 104 is interacting with the far side (e.g. sending data to the far-side) in the real-time communication event. As such, when the user 104 is not interacting with the far side in the real-time communication event, the data rate of the data stream received at the user terminal 102 may be increased. In other words the optimum trade-off between data rate and delay on the data stream received at the user terminal 102 in the real-time communication event is such that the data rate and the delay are both increased when the user 104 is not interacting with the far-side (e.g. when the user is not sending data to the far-side) in the real-time communication event compared to when the user 104 is interacting with the far-side (e.g. when the user is sending data to the far-side) in the real-time communication event. The associated increase in delay is of little consequence due to the manner in which the user 104 is currently interacting in the real-time communication event.

Identified below are further user behaviour patterns that may influence the trade-off between data rate and delay. There are described below examples, relating to the interaction of the user 104 with the real-time communication application implemented by the client software at the user terminal 102, that should lead to a lower optimum data rate and thus a lower delay in the trade-off between data rate and delay.

In order to determine interaction of the user 104 with the real-time communication application, the user terminal 102 (in particular the real-time communication application implemented by the client software at the user terminal 102) may determine whether delay on the received data stream is causing a problem to communication in the real-time communication event. For example, the data rate of the received data stream may be decreased if it is determined that delay on the received data stream is causing a problem to communication in the real-time communication event, thereby allowing the delay to be reduced. In order to determine whether delay is causing a problem to communication in the real-time communication event the real-time communication application may detect a doubletalk condition in the real-time communication event. In a call, high communication delay may lead to a doubletalk condition, that is, a condition in which the users of the call interrupt each other unintentionally. Therefore, if doubletalk is detected, the data rate of the data streams transmitted in both directions in the real-time communication event may be reduced to thereby reduce the delay, and to reduce the occurrence of doubletalk. As an example, a doubletalk condition may be determined to be present if the frequency with which the users of the call interrupt each other during the call exceeds a threshold frequency.

In some embodiments the receiving terminal of a real-time communication event (e.g. user terminal 102 when it acts as a receiver to receive a data stream from the user terminal 108) determines interaction of the receiving user with the real-time communication application implemented at the receiving terminal. Based on the determined interaction, the receiving terminal determines a target data rate (or bandwidth) for the received data stream as described herein. An indication of the target data rate is sent to the transmitting terminal of the real-time communication event that sends the data stream to the receiving terminal (e.g. the transmitting terminal is the user terminal 108 when it acts as a transmitter to transmit a data stream to the user terminal 102). The transmitting terminal then transmits the data stream to the receiving terminal according to the target data rate. In these embodiments the receiving terminal determines the target data rate from the interaction of the user with the real-time communication application implemented at the receiving terminal.

In some embodiments, an indication of the determined interaction is sent to the transmitting terminal of the real-time communication event that sends the data stream to the receiving terminal (e.g. the transmitting terminal is the user terminal 108 when it acts as a transmitter to transmit a data stream to the user terminal 102). Based on the determined interaction, the transmitting terminal determines a target data rate (or bandwidth) for the data stream as described herein. The transmitting terminal then transmits the data stream to the receiving terminal according to the target data rate. In these embodiments the transmitting terminal determines the target data rate from the interaction of the user with the real-time communication application implemented at the receiving terminal.

It can therefore be seen that in some embodiments the data rate of a transmitted data stream is controlled based on the receiving user's interaction with a real-time communication application implemented at the receiving user terminal. The methods may be implemented at each end of a real-time communication event such that control of the data rate of data streams in each direction in a real-time communication event can be controlled. The real-time communication event may include two or more end points. For example, a call between two users of the system 100 has two end points, whilst a conference call between multiple users of the system 100 may have a respective multiple end points.

Alternatively, the transmitting user terminal may control the data rate of the data stream that it transmits in a real-time communication event based on the interaction of a user with a real-time communication application implemented at the transmitting terminal. For example, the user terminal 102 may control the data rate of the data stream that it transmits to the user terminal 108 based on the interaction of the user 104 with the real-time communication application implemented at the user terminal 102. For example, if the real-time communication application implemented at the user terminal 102 detects a doubletalk condition in a call, the data rate of the data stream transmitted from the user terminal 102 to the user terminal 108 in the call may be decreased to thereby reduce the delay in the transmitted data stream with the aim of reducing the occurrence of doubletalk.

In order to determine interaction of the user 104 with the real-time communication application, the user terminal 102 (in particular the real-time communication application implemented by the client software at the user terminal 102) may determine whether the user's attention is on the outputted data. The data rate of the received data stream in the real-time communication event may be controlled such that it is decreased if the user's attention is not on the outputted data.

For example, it may be determined that the user 104 does not have his attention on video data of a video call if the user is not in an image captured by the camera 208 at the user terminal 102 for transmission in the video call. This may be a sign that the user 104 is not in front of his user terminal 102, and thus not watching the video data output by the real-time communication application on the display 204. On that basis it may be determined that the user 104 is not viewing the video data of the received data stream. However, the user 104 may still be interacting with the far-side via an audio signal, such that the latency of the transmission of the data stream is still important. Therefore, it is determined that the video quality is of less concern than delay in the video call, and as such the data rate of the received data stream can be reduced to thereby reduce the associated delay.

As another example it may be determined that the user 104 does not have his attention on video data of a video call if a user interface of the real-time communication application which outputs the video data of the received data stream is minimized, hidden or out-of-focus on the display 204 of the user terminal 102. These events are indications that the user 104 is not watching the video data output by the real-time communication application in the video call. However, the user 104 may still be interacting with the far-side via an audio signal, such that the latency of the transmission of the data stream is still important. Therefore, it is determined that the video quality is of less concern than delay in the video call, and as such the data rate of the received data stream can be reduced to thereby reduce the associated delay.

The methods described herein may be implemented by the real-time communication application implemented by the client software at the user terminal 102. In this way, the client software is a computer program product configured to process data of a real-time communication event, wherein the computer program product is embodied on a tangible computer-readable hardware medium and configured so as when executed on the processor 202 of the user terminal 102 to implement the real-time communication application to perform the operations of the methods described herein. Computer-readable hardware media is intended to describe all statutory forms of computer-readable media and thus excludes non-statutory forms of media. The user terminal 102 is an end point of the real-time communication event between the user terminals 102 and 108, wherein the user terminal 102 acts as a receiver for the data stream sent from the user terminal 108 to the user terminal 102, and the user terminal 102 acts as a transmitter for the data stream sent from the user terminal 102 to the user terminal 108. Corresponding methods may be implemented at the user terminal 108, thereby allowing the data rate of data streams sent in both directions between the user terminals 102 and 108 to be controlled according to the methods described herein.

The methods described herein may be implemented dynamically during a real-time communication event. This allows the data rate of the data streams to be dynamically controlled. The data rate of a data stream may be controlled based on the current interaction of the user 104 with the real-time communication application implemented at the user terminal 102.

The interaction of the user 104 with the real-time communication application implemented at the user terminal 102 describes how the user 104 is engaging in the real-time communication event. In other words, the interaction of the user 104 with the real-time communication application describes how the user is involved in the real-time communication event. For example, the interaction of the user 104 with the real-time communication application may describe at least one of: (i) the manner in which the user 104 receives data of the real-time communication event, and (ii) the manner in which the user 104 inputs data for transmission in the real-time communication event.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A receiver configured to process data of a real-time communication event, the receiver comprising a processing module configured to implement a real-time communication application to:
receive a data stream of the real-time communication event;
output data of the received data stream to a user in the real-time communication event;
determine interaction of the user with the real-time communication application during the real-time communication event; and
control the data rate of the received data stream in the real-time communication event based on the determined interaction.

2. The receiver of claim 1 wherein in order to control the data rate of the received data stream in the real-time communication event the processing module is configured to implement the real-time communication application to send a control signal to a transmitter which transmits the data stream in the real-time communication event to the receiver, the control signal comprising an indication of a target data rate.

3. The receiver of claim 1 wherein in order to control the data rate of the received data stream in the real-time communication event the processing module is configured to implement the real-time communication application to send a control signal to a transmitter which transmits the data stream in the real-time communication event to the receiver, the control signal comprising an indication of the determined interaction thereby enabling the transmitter to determine a target data rate based on the determined interaction.

4. The receiver of claim 1 wherein in order to determine interaction of the user with the real-time communication application the processing module is configured to implement the real-time communication application to determine whether the user is inputting data to the real-time communication application for transmission in the real-time communication event.

5. The receiver of claim 4 wherein the processing module is configured to implement the real-time communication application to control the data rate of the received data stream in the real-time communication event such that the data rate of the received data stream is increased if it is determined that the user is not inputting data to the real-time communication application for transmission in the real-time communication event.

6. The receiver of claim 4 wherein in order to determine whether the user is inputting data to the real-time communication application for transmission in the real-time communication event the processing module is configured to implement the real-time communication application to perform at least one of:
determining whether the user has muted a microphone at the receiver,
determining whether the user has activated a listening mode at the receiver, and
detecting at least one of audio or video input from the user.

7. The receiver of claim 1 wherein in order to determine interaction of the user with the real-time communication application the processing module is configured to implement the real-time communication application to determine whether delay is causing a problem to communication in the real-time communication event.

8. The receiver of claim 7 wherein the processing module is configured to implement the real-time communication application to control the data rate of the received data stream in the real-time communication event such that the data rate of the received data stream is decreased if it is determined that delay is causing a problem to communication in the real-time communication event.

9. The receiver of claim 7 wherein in order to determine whether delay is causing a problem to communication in the real-time communication event the processing module is configured to implement the real-time communication application to detect a doubletalk condition.

10. The receiver of claim 1 wherein the processing module is further configured to implement the real-time communication application to:
transmit a data stream in the real-time communication event; and
control the data rate of the transmitted data stream in the real-time communication event based on the determined interaction.

11. The receiver of claim 10 wherein in order to determine interaction of the user with the real-time communication application the processing module is configured to implement the real-time communication application to determine whether delay is causing a problem to communication in the real-time communication event, and wherein the processing module is configured to implement the real-time communication application to control the data rate of the transmitted data stream in the real-time communication event such that the data rate of the transmitted data stream is decreased if it is determined that delay is causing a problem to communication in the real-time communication event.

12. The receiver of claim 1 wherein in order to determine interaction of the user with the real-time communication application the processing module is configured to implement the real-time communication application to determine whether the user's attention is on the outputted data.

13. The receiver of claim 12 wherein the processing module is configured to implement the real-time communication application to control the data rate of the received data stream in the real-time communication event such that the data rate of the received data stream is decreased if it is determined that the user's attention is not on the outputted data.

14. The receiver of claim 12 wherein the received data stream comprises video data and audio data, and wherein the processing module is configured to implement the real-time communication application to determine that the user's attention is not on the outputted data by either:
(i) detecting that the user is not in an image captured by a camera at the receiver for transmission in the real-time communication event, and on that basis determining that the user is not viewing the video data of the received data stream; or
(ii) determining that a user interface of the real-time communication application which outputs the video data of the received data stream at the receiver is minimized, hidden or out-of-focus.

15. A computer program product configured to process data of a real-time communication event, the computer program product being embodied on a tangible computer-readable hardware medium and configured so as when executed on a processor of a receiver of the real-time communication event to implement a real-time communication application to perform the operations of:
receiving a data stream of the real-time communication event;
outputting data of the received data stream to a user in the real-time communication event;
determining interaction of the user with the real-time communication application during the real-time communication event; and
controlling the data rate of the received data stream in the real-time communication event based on the determined interaction.

16. The computer program product of claim 15 wherein said controlling the data rate of the received data stream in the real-time communication event comprises sending a control signal to a transmitter which transmits the data stream in the real-time communication event to the receiver, the control signal comprising an indication of a target data rate.

17. The computer program product of claim 15 wherein said determining interaction of the user with the real-time communication application comprises determining whether the user is inputting data to the real-time communication application for transmission in the real-time communication event.

18. The computer program product of claim 15 wherein said determining interaction of the user with the real-time communication application comprises determining whether delay is causing a problem to communication in the real-time communication event.

19. The computer program product of claim 15 wherein said determining interaction of the user with the real-time communication application comprises determining whether the user's attention is on the outputted data.

20. A method of processing data of a real-time communication event using a real-time communication application at a receiver, the method comprising:
receiving a data stream of the real-time communication event from a transmitter;
outputting data of the received data stream to a user in the real-time communication event;
determining interaction of the user with the real-time communication application during the real-time communication event; and
controlling the data rate of the received data stream in the real-time communication event based on the determined interaction by sending a control signal to the transmitter, the control signal comprising either (i) an indication of a target data rate or (ii) an indication of the determined interaction thereby enabling the transmitter to determine a target data rate based on the determined interaction.
